(19) United States
(12) Patent Application Publication
(10) Pub. No.: US 2024/0377132 A1
(43) Pub. Date: Nov. 14, 2024

(54) DISTRIBUTOR MODULE FOR A PROCESS PLANT

(71) Applicant: Linde GmbH, Pullach (DE)

(72) Inventors: Stefan LOCHNER, Pullach (DE); Stefan SCHROLL, Pullach (DE)

(21) Appl. No.: 18/688,645

(22) PCT Filed: Aug. 29, 2022
(86) PCT No.: PCT/EP2022/025398

§ 371 Date: Mar. 1, 2024

(30) Foreign Application Priority Data
Sep. 7, 2021 (EP) 21020451.7

(51) Int. Cl. F25J 3/04

(52) U.S. Cl. CPC F25J 3/0489; F25J 3/04018; F25J 3/04181; F25J 2205/70

(57) ABSTRACT

A distributor module for a process plant, in particular an air-separation plant, which can be connected by means of fluid lines to a main-air-compressor arrangement, at least two adsorbers, each of which can be operated in an adsorption phase and a regeneration phase, and a main-heat-exchanger arrangement, comprising a compressor connection, comprising, for each adsorber to be connected, a pair of connections having a first adsorber connection and a second adsorber connection, comprising a first heat-exchanger connection and a second heat-exchanger connection, and comprising a residual-gas connection or a residual-gas outlet; and a valve-and-flap assembly which is designed to act, according to choice, for each pair of connections, in a first state of the pair of connections, or; in a second state of the pair of connections.

The invention relates to a distributor module for a process engineering system, in particular for an air separation plant, and an air separation plant.

### PRIOR ART

The production of air products in the liquid or gaseous state by low temperature separation of air in air separation installations is known and described, for example, in H.-W. Häring (editor), Industrial Gases Processing, Wiley-VCH, 2006, in particular Section 2.2.5, “Cryogenic Rectification.”

Air separation plants have rectification column systems or distillation column systems which, for example, can conventionally be designed as two-column systems, in particular as classical Linde double-column systems, but also as triple-column or multi-column systems. In addition to the rectification columns for extracting nitrogen and/or oxygen in the liquid and/or gaseous state, i.e., rectification columns for nitrogen-oxygen separation, rectification columns for extracting further air components, in particular the noble gases krypton, xenon, and/or argon, can be provided. Frequently, the terms “rectification” and “distillation” as well as “column [Säule]” and “column [Kolonne]” or terms composed therefrom are used synonymously.

To provide compressed nitrogen as the main product, the prior art also discloses the low-temperature separation of air according to the so-called SPECTRA process, as described, inter alia, in EP 2 789 958 A1 and the further patent literature cited therein. In its simplest form, this method is a single-column method.

Air separation comprises the basic steps of compression, precooling, purification, cooling and rectification. The compression takes place, for example, in multistage turbocompressors with intermediate and post-cooling to a pressure of about 5 bar or more. Dust particles can be removed in so-called intensive filters before compression. For subsequent precooling, direct contact coolers operated with water can be used in which water-soluble impurities can also be partially washed out. The utilized water can, for example, be recooled in trickle evaporation coolers against residual nitrogen gas from the rectification (also referred to as “cooling nitrogen”).

The precooled air is generally purified or cleaned in adsorbers or molecular sieve adsorbers. Moisture, carbon dioxide, and hydrocarbons are removed therein. Generally two (or more) adsorbers are provided which are each operated alternately in an adsorption phase or a regeneration phase so that continuous operation of the air separation plant is ensured.

For liquefaction, the air purified in this way is cooled to about −175° C. in one or more main heat exchangers. The cooling takes place by internal heat exchange in a countercurrent to cold gas streams generated in the plant. Here as well, at least residual nitrogen gas from the rectification is generally used. A gas can also be used here which is significantly richer in oxygen O₂ than air, up to pure O₂. During a subsequent expansion, the air cools further by the Joule-Thomson effect and liquefies. The actual breakdown (rectification) of the air takes place in separation columns (rectification columns) of a separation column system, wherein firstly an oxygen-rich bottom fraction and a nitrogen-rich top fraction are produced.

The air separation plants are generally assembled from prefabricated components. However, this is often problematic because sufficiently qualified personnel for installation are either unavailable or expensive. In particular, this relates to the connection of the adsorbers to the compressor stage and to the cooling stage. Therefore, there is a need for improvements that enable air separation plants to be built more reliably and easily.

### DISCLOSURE OF THE INVENTION

According to the invention, the object is achieved by a distributor module and an air separation plant having the features of the independent claims; dependent claims relate to preferred embodiments.

Prior to explaining the features and advantages of the present invention, some of the principles of the present invention will be explained in greater detail, and terms used below will be defined.

The devices used in an air fractionation installation are described in the cited technical literature, for example in Häring (see above) in Section 2.2.5.6, “Apparatus.” Unless the following definitions differ, reference is therefore explicitly made to the cited technical literature with respect to terminology used within the framework of the present application.

Liquids and gases may, in the terminology used herein, be rich or poor in one or more components, wherein “rich” can refer to a content of at least 75%, 90%, 95%, 99%, 99.5%, 99.9%, or 99.99%, and “poor” can refer to a content of at most 25%, 10%, 5%, 1%, 0.1%, or 0.01% on a mole, weight, or volume basis. The term “predominantly” can correspond to the definition of “rich.” Liquids and gases may also be enriched in or depleted of one or more components, wherein these terms refer to a content in a starting liquid or a starting gas from which the liquid or gas has been extracted.

The liquid or the gas is enriched if it contains at least 1.1 times, 1.5 times, 2 times, 5 times, 10 times, 100 times, or 1000 times the content, and depleted if it contains at most 0.9 times, 0.5 times, 0.1 times, 0.01 times, or 0.001 times the content of a corresponding component, based on the starting liquid or the starting gas. If, for example, reference is made here to “oxygen,” “nitrogen,” or “argon,” this is also understood to mean a liquid or a gas which is rich in oxygen or nitrogen but need not necessarily consist exclusively thereof.

The present application uses the terms “pressure level” and “temperature level” to characterize pressures and temperatures, which means that corresponding pressures and temperatures in a corresponding plant do not have to be used in the form of exact pressure or temperature values in order to realize the inventive concept. However, such pressures and temperatures typically fall within certain ranges, which are, for example, +1%, 5%, 10%, or 20% around an average. In this case, corresponding pressure levels and temperature levels can be in disjointed ranges or in ranges that overlap one another. In particular, pressure levels, for example, include unavoidable or expected pressure losses. The same applies to temperature levels. The pressure levels indicated here in bar are absolute pressures.

Where “expansion machines” are mentioned here, these refer to typically known turboexpanders. These expansion machines can, in particular, also be coupled to compressors. These compressors may in particular be turbocompressors. A corresponding combination of turboexpander and turbocompressor is typically also referred to as a “turbine booster.” In a turbine booster, the turboexpander and the turbocompressor are mechanically coupled, wherein the coupling may take place at the same rotational speed (for example via a common shaft) or at different rotational speeds (for example via suitable gearing). In general, the term “compressor” is used herein. Here, a “cold compressor” refers to a compressor to which a fluid stream is supplied at a temperature level significantly below 0° C., in particular below −50, −75, or −100° C. and up to −150 or −200° C. A corresponding fluid stream is cooled to a corresponding temperature level in particular by means of a main heat exchanger (see below).

A “main air compressor” is characterized in that it compresses all of the air supplied to the air fractionation plant and separated there. In contrast, in one or more optionally provided additional compressors, for example booster compressors, only a portion (up to a multiple if the air here is being circulated) of this air that has already been previously compressed in the main air compressor is further compressed. Accordingly, the “main heat exchanger” of an air fractionation plant represents the heat exchanger in which at least the predominant part of the air supplied to the air fractionation plant and separated there is cooled. This takes place at least in part and possibly only in counterflow to material streams that are discharged from the air fractionation plant. In the terminology used herein, material streams or “products” “discharged” from an air fractionation plant are fluids that no longer participate in circuits within the plant but are permanently removed therefrom.

A “heat exchanger” for use in the context of the present invention can be designed in a manner customary in the art. It serves for the indirect transfer of heat between at least two fluid streams which are, for example, conducted in counterflow to one another, for example, a warm compressed air stream and one or more cold fluid streams or a cryogenic liquid air product and one or more warm or warmer but possibly also even cryogenic fluid streams. A heat exchanger can be formed from one or more heat exchanger sections connected in parallel and/or serially, e.g., from one or more plate heat exchanger blocks. It is, for example, a plate fin heat exchanger. Such a heat exchanger has “passages” which take the form of fluid channels separated from one another and having heat exchange surfaces, and which are connected together in parallel and separated by other passages to form “passage groups.” The characteristic of a heat exchanger is that at one time heat is exchanged therein between two mobile media, namely at least one fluid stream to be cooled and at least one fluid stream to be heated.

A “condenser evaporator” refers to a heat exchanger in which a condensing fluid stream enters into indirect heat exchange with an evaporating fluid stream. Each condenser evaporator has a liquefaction chamber and an evaporation chamber. The liquefaction and evaporation chambers have liquefaction or evaporation passages. Condensation (liquefaction) of the condensing fluid stream is carried out in the liquefaction chamber, and evaporation of the evaporating fluid stream is carried out in the evaporation chamber. The evaporation and liquefaction chambers are formed by groups of passages, which are in a heat-exchanging relationship with one another.

In particular, devices for separating gas mixtures which enhance the physical effect of adsorption, i.e., that substances or molecules from gases or liquids accumulate on the surface of a solid body, are referred to as “adsorbers” or “molecular sieve adsorbers.” The adsorbed substances/molecules can be removed again from the surface of the solid body using a cleaning gas which is passed through the adsorber. In air separation plants, before being cooled to low temperatures, the air compressed by the main air compressor is purified of impurities, in particular H₂O, CO₂ and acetylenes by means of adsorbers. Preferably, zeolite adsorbers are used, i.e., adsorbers which contain zeolite crystals, on the surface of which the substances to be adsorbed accumulate, wherein the adsorption takes place in pores having a diameter of about 1 nm in the surface of the zeolite crystals. The zeolite crystals are bonded by a ceramic material, wherein spherical or rod-shaped elements having a dimension in the millimeter range are formed.

In air separation plants, multiple adsorbers are generally provided, in particular two adsorbers which are operated alternately in an adsorption phase and a regeneration phase. During the adsorption phase, air coming from the main air compressor is guided through the adsorber, typically at a pressure level of from 5 to 40 bar. Subsequently, the pressure is first lowered to ambient pressure and, in the regeneration phase, a cleaning gas, generally dry residual nitrogen which is removed from a rectification column and guided through the main heat exchanger, is conducted through the adsorber in the counterflow direction, wherein a warm-up phase with warm cleaning gas and a cooling phase with cold cleaning gas are provided. Subsequently, the pressure level in the adsorber is again increased to the pressure level of the air coming from the main air compressor. The adsorption generally takes place under the final pressure of the main air compressor. The regeneration is carried out under the lowest possible pressure with dry gas which is removed after the adsorbers. Since multiple adsorbers are provided, uninterrupted cleaning of the air can be achieved.

The term “module” is to be understood as an assembly of interconnected elements which are fixedly arranged in the module. The elements are connected to one another by a support structure, for example a support frame, a support housing or the like. A module thus represents a structural unit in which the elements are fixedly arranged. In particular, the module or its element can be moved as a whole, for example transported from a production site to a construction site.

The expression “fluidically connected” is to be understood in the sense of being connected by a fluid line. It can be exchanged as a fluid between fluidically connected elements.

The relative spatial terms “upper,” “lower,” “over,” “under,” “above,” “below,” “adjacent to,” “next to,” “vertical,” “horizontal,” etc. here refer to the spatial orientation of the distillation columns of an air separating installation in normal operation. An arrangement of two distillation columns or other components “one above the other” is understood here to mean that the upper end of the lower of the two apparatus parts is located at a lower geodetic height than or the same geodetic height as the lower end of the upper of the two apparatus parts and the projections of the two apparatus parts overlap in a horizontal plane. In particular, the two apparatus parts can be arranged exactly one above the other, that is to say the axes of the two columns run on the same vertical straight line.

A distributor module according to the invention for a process engineering plant can be connected to a main air compressor arrangement, at least two adsorbers, each of which can be operated in an adsorption phase and a regeneration phase, and a main heat exchanger arrangement by means of fluid lines, and comprises a compressor connection, for each adsorber to be connected, a connection pair with a first adsorber connection and a second adsorber connection, a first heat exchanger connection and a second heat exchanger connection, and a residual gas connection or a residual gas outlet; and a valve and flap assembly. For each connection pair, the valve and flap assembly is optionally configured (i.e., in particular correspondingly controllable): in a first state of the connection pair, to fluidically connect the compressor connection to the first adsorber connection of the connection pair and to fluidically connect the second adsorber connection of the connection pair to the first heat exchanger connection, or in a second state of the connection pair, to fluidically connect the second heat exchanger connection to the second adsorber connection of the connection pair and to fluidically connect the first adsorber connection of the connection pair to the residual gas connection or a residual gas outlet. The distributor module has a floor side, and a height of the distributor module measured perpendicular to the floor side is greater than both transverse dimensions of the distributor module measured parallel to the floor side. This condition can be formulated such that the side surfaces of an imaginary, minimally small cuboid that encloses the distributor module are higher than the sides/edges of the surface (floor side) on which it stands.

The process engineering plant is preferably an air separation plant.

The integration of the valve and flap assembly, which typically comprises a plurality of valves or flaps in order to alternately conduct the fluid flows (air flow, regeneration gas flow) to the adsorbers in a module, allows rapid and easy installation, wherein, after the distributor module has been placed on the floor side, substantially only the connections via fluid lines need to be connected to the additional assemblies (main air compressor arrangement, adsorber, main heat exchanger arrangement). Due to the fact that the height relative to the transverse dimension is large, a reduced area requirement is achieved on a total area of the process engineering system or air separation plant.

The “floor side” represents the side of the distributor module on which it is to be erected on a floor area of the process engineering plant (in particular air separation plant) for operation, i.e., the floor side is correspondingly set up or designed. In the erected state, the floor side is thus at the bottom. The floor side is typically not formed by a closed side wall or the like. Rather, frame elements are typically provided there which can be anchored directly or indirectly to the floor. The transverse dimension can be, for example, a maximum or an average dimension or expansion of the distributor module measured parallel to the floor side.

Preferably, the height is greater than the transverse dimension by at least 1.5 times, more preferably at least 2 times, even more preferably at least 3 times, most preferably more than 5 times. The transverse dimension of one of a maximum dimension of the distributor module parallel to the floor side, an average dimension of the distributor module parallel to the floor side, is preferably the root of an area of the floor side. Preferably, the height should be at most 5 times the transverse dimension. These relative dimensions or characterizations allow a small floor side of the distributor module and thus indirectly a small total area of the air separation plant, taking into account typical size requirements of valves/flaps and fluid lines. At the same time, easy transport of the distributor module is possible.

The “height” of the distributor module is the dimension of the distributor module measured in the erected state (during normal operation) in the vertical direction and corresponds to a “transport length” during transport. The height direction corresponds to the vertical direction. The just mentioned “transverse dimensions” are the dimensions of the distributor module measured in the erected state in the horizontal direction (i.e., orthogonally to the vertical direction). “Top” and “bottom”, furthermore “above” and “below” are defined starting from the floor side, i.e., the floor side is the floor side of the distributor module. The floor side thus correspondingly runs in the horizontal direction. As already explained above, an arrangement of components “on top of each other” means that the upper end of the lower of the two components is located below (at a lower or the same geodetic height when erected), just as the lower end of the upper of the two components and the vertical projections of the two components overlap in a horizontal plane. In particular, the two components can be arranged exactly one above the other. In this case, components can be apparatus parts of the distributor module, in particular apparatus parts (e.g., valves and/or flaps) of the valve and flap assembly.

The distributor module preferably comprises a regeneration gas heater which is fluidically connected to the second heat exchanger connection. Preferably, the distributor module comprises fluid lines and/or fluid connections for connection to a booster, which can accordingly be fluidically connected to the first heat exchanger connection. The regeneration gas heater is in particular heatable and is configured to heat a regeneration gas. Corresponding lines for supplying energy can also be comprised in the distributor module. These embodiments lead to a further integration and hence to a further simplification of installation. Alternatively or in addition to a regeneration gas heater comprised in the distributor module, fluid lines and/or fluid connections can also be provided in the distributor module, and enable the establishment of a fluidic connection to an external regeneration gas heater which is not integrated in the distributor module.

Preferably, the distributor module comprises a control unit which is configured to control the valve and flap assembly, wherein a connection pair is operated according to the first state in order to operate the adsorber connected thereto in the adsorption phase, and is operated according to the second state in order to operate the adsorber connected thereto in the regeneration phase, wherein more preferably, the control unit is configured to control the valve and flap assembly so that at least one pair of connections is operated alternately according to the first state. The control unit is advantageously accommodated in a housing or container which has access, for example in the form of a door. All instruments that electrically transmit their signals can be connected to the I/O maps of the process control system, which are then also located on the distributor module and increase the degree of prefabrication.

The distributor module preferably comprises an instrument air distribution arrangement with instrument air lines which are fluidically connected to control connections of valves and/or flaps comprised in the valve and flap assembly, wherein more preferably, I/O cards are arranged on the distributor module and are connected for data exchange with control elements of the instrument air distribution arrangement which are used for switching instrument air, wherein the I/O cards can be connected to data cables, in particular bus cables, wherein the control unit is optionally connected to the I/O cards by means of data cables (for data exchange). The control or the movement of the valves/flaps which are contained in the distributor module can take place pneumatically by means of so-called instrument air. The instrument air is guided via instrument air lines to control connections of the valves/flaps. The instrument air distribution arrangement comprises in particular switching elements (which are connected to the instrument air lines) by means of which the pressurization of individual instrument air lines can be controlled. The switching elements (e. g., valves) can be controlled by means of electrical switching signals which are transmitted by the control unit via data cables. A bus or field bus can in particular be used for this purpose. A typical design of a control unit or a control system which can comprise parts arranged on the distributor module, can look as follows: A process control system (i.e., in particular control software which runs on a computer) is connected via bus cables or the like to I/O cards (Input/Output cards), which, for example, by means of a 4-20 mA signal, actuate the switching elements which then open or close the control air/instrument air for the valves. In the reverse direction, signals of the switching elements (instruments) and measurement values are transmitted via the I/O cards and the bus cable to the process control system. The I/O cards are preferably arranged on the distributor module. A device for instrumentation air treatment can preferably also be arranged or mounted in the distributor module.

The distributor module preferably comprises one or more measuring devices, in particular temperature measuring devices and/or pressure measuring devices and/or quantity measuring devices, wherein the one or more measuring devices (in particular via I/O cards) are optionally connected to the control unit by means of data cables in order to transmit measured values to the control unit. All data required for control can thus be detected and used by the control unit for controlling. The degree of prefabrication can accordingly be further increased.

Preferably, the distributor module comprises a blowdown silencer arranged at the residual gas connection or residual gas outlet. The term “residual gas outlet” is to denote a component via which a residual gas is released to the surroundings or atmosphere. If there is any excess residual gas which is not required for adsorber regeneration, it can also be conducted into an evaporation cooler which cools water by evaporative cooling. This cold water can be used to cool the process air before entry into the adsorber which is in the adsorption phase.

Preferably, the distributor module comprises a support frame, in particular a steel support frame, on which the valve and flap assembly, optionally the regeneration gas heater, optionally the control unit or parts thereof, optionally the post-compressor, and optionally the blowdown silencer, are mounted, wherein fluid lines for connecting these elements and for connection to the compressor connection, the first and the second heat exchanger connection and the first and the second adsorber connection are likewise mounted on the support frame. A support frame leads to high stability of the distributor module. Accesses, e.g., stairs, platforms and doors, to the components of the distributor module can advantageously be attached or attachable to the support frame (to fastening elements provided for this purpose).

Further preferably, the support frame is substantially cuboid (i.e., has a cuboid outer contour or a cuboid outline) and has a length, a width and a depth, wherein the height is equal to the length and the transverse dimension is equal to the width, the depth or an average thereof, wherein preferably, the width and the depth are independently within the range of 3, 5 m to 7 m, and preferably, the length is preferably within the range of 10 m to 30 m, more preferably within the range of 15 m to 25 m, still more preferably within the range of 15 m to 20 m.

Preferably, when the distributor module is connected to the main air compressor arrangement, the at least two adsorbers and the main heat exchanger arrangement, the distributor module is configured to direct an air flow to the adsorber for each of the adsorbers independently of each other during the adsorption phase of the respective adsorber, and from the adsorber to the main heat exchanger arrangement after the air flows through the adsorber and, during the regeneration phase of the respective adsorber, to direct a regeneration gas flow from the main heat exchanger arrangement to the adsorber and, after the air flows through the adsorber, to direct it to a residual gas outlet. The valve and flap assembly can be correspondingly actuated via a control device which can be comprised in particular in the distributor module.

Preferably, the control fittings, namely first valves and/or flaps, which shut off/release the fluid flows from the compressor connection to the adsorbers or to the connection pairs, are arranged horizontally or almost horizontally in the distributor module or in the valve and flap assembly. Flaps are preferably arranged in a horizontal plane; wherein more preferably, the flaps, in particular if these are three-lever flaps, are arranged horizontally or almost horizontally. The flaps, which switch the air path or the regeneration gas to the adsorbers, are preferably designed as three-lever flaps which are installed horizontally. The flaps can be arranged open, i.e., the line branches before the flaps, and have a supplying regeneration gas line, or a regeneration gas line splits and only one air line is supplied which is first distributed in a T-piece between the flaps.

Preferably, second valves and/or flaps which shut off/release the fluid flows between connection pairs and the heat exchanger connections are arranged in the distributor module or in the valve and flap assembly in a vertical or almost vertical plane; wherein the second valves and/or flaps are preferably arranged spatially above the first valves and/or flaps. In other words, the control fittings (i.e., valves and/or flaps) that shut off/release the fluid flows to the main heat exchanger arrangement or to the heat exchanger connections are preferably arranged in a vertical plane in the distributor module or in the valve and flap assembly. Here as well, the (second) flaps can optionally be arranged horizontally or almost horizontally, in particular if they are three-lever flaps.

More preferably, the control fittings (i.e., valves and/or flaps) which shut off/release the fluid flows to the adsorbers or to the connection pairs are arranged in the distributor module or in the valve and flap assembly spatially above or spatially below the control fittings (i.e., valves and/or flaps) which shut off/release the fluid flows to the main heat exchanger arrangement or to the heat exchanger connections.

Preferably, the control fittings (i.e., valves and/or flaps, both to the connection pairs and to the heat exchanger connections) are arranged as close as possible to the connection pairs in the distributor module or in the valve and flap assembly.

All control fittings or flaps designed as three-lever flaps are preferably installed in horizontal or horizontally running lines.

A device for pressure reduction of gaseous oxygen (GOX) is preferably comprised or mounted in the distributor module. An associated fire protection device can also be provided on the distributor module.

Preferably, in the distributor module, a branch is provided that is fluidically connected to the second heat exchanger connection, through which the residual gas line from the main heat exchanger arrangement is split to regenerate the adsorbers (i.e., to a respective second adsorber connection, and subsequently to the silencer) or to an evaporative cooler for pre-cooling.

An air separation plant according to the invention comprises a distributor module according to the invention and further comprises a main air compressor arrangement, at least two adsorbers, each of which can be operated in an adsorption phase and a regeneration phase, and a main heat exchanger arrangement which are connected to the distributor module by means of fluid lines. Preferably, the distributor module also comprises some or more connecting process lines from and to the main heat exchanger.

The air separation plant further preferably comprises a separation column arrangement, wherein the main heat exchanger arrangement is arranged between the distributor module and the separating column arrangement, wherein the main heat exchanger arrangement is preferably mounted in a main heat exchanger module, and/or the separating column arrangement is mounted in a separating column module. By arranging or placing the main heat exchanger arrangement between the distributor module and separating column arrangement, a particularly small space requirement can be achieved.

In the air separation plant, the height of the distributor module in relation to a heat exchanger height of the main heat exchanger arrangement or the main heat exchanger module is between the heat exchanger height minus 5 m and heat exchanger height plus 5 m, wherein the height of the distributor module is preferably greater than the heat exchanger height (i.e., the height of the upper edge of the heat exchanger in the main heat exchanger module when it is installed).

In the adsorption phase, the flow through the adsorbers is preferably from the bottom to the top and, in the regeneration phase, the flow is preferably from top to bottom. That is, the connections of the adsorbers are accordingly connected to the associated connection pair of the distributor module.

In the air separation plant, the distributor module is preferably arranged directly next to the main heat exchanger arrangement or the main heat exchanger module, wherein a distance is less than 4 m (meters), more preferably less than 2 m, most preferably less than 1 m. The larger connecting lines (LPGAN, residual gas, etc.) can be guided in a plane parallel to the main heat exchanger module close to the main heat exchanger module.

In the air separation plant, the adsorbers are preferably arranged at the smallest possible distance from the distributor module (measured as the distance of a side wall of the adsorbers, e.g., container wall, to the distributor module), preferably at a distance of less than 2 m, more preferably at a distance of less than 1 m.

The air separation plant preferably comprises a device for the pressure reduction of gaseous oxygen (GOX) and/or a fire protection device. More preferably, these are optionally comprised or mounted in the distributor module.

The invention is described in more detail hereafter with reference to the accompanying drawings, which illustrate preferred embodiments of the present invention.

### BRIEF DESCRIPTION OF THE DRAWINGS

FIG. 1 shows an air separation plant according to the prior art in a highly simplified schematic representation.

FIGS. 2A and 2B show a plan view and a side view of an air separation plant in which a distributor module according to one embodiment of the invention is arranged.

FIGS. 3A and 3B schematically show, in the valve and flap arrangement, exemplary arrangements of valves and flaps.

### DETAILED DESCRIPTION OF THE DRAWINGS

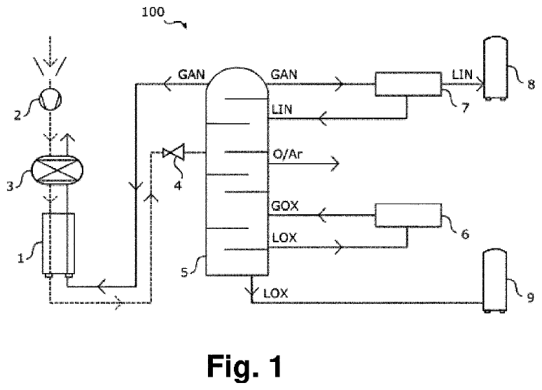

FIG. 1 shows an air separation plant according to the prior art in a highly simplified schematic representation. This is denoted as a whole by 100.

The heat exchanger block 1, which can comprise one or more heat exchangers in a corresponding cold box (i.e., thermally insulating walls which surround a region to be thermally insulated), is supplied to an air flow shown by dashed lines, which was previously compressed in a compressor 2 and purified in an adsorber device 3. Additional devices such as filters and the like, such as pre-cooling, are not shown. In general, the compressed air stream can be divided into multiple fractions which are recompressed to different pressure levels and are conveyed separately from one another through the heat exchanger block (not shown). The adsorber device 3 usually comprises multiple adsorbers which can be operated in alternating mode and can be regenerated accordingly.

In the heat exchanger 1, the supplied, compressed and purified air is supplied in counterflow with cold, gaseous nitrogen UN₂ and pure GAN from the head of a separation column 5 explained below (and optionally further process streams which are brought to ambient temperature, i.e., enriched UN₂, GAN, GOX IC, GAN IC, etc.). After it has been guided through the heat exchanger 1 for cooling the purified air, at least a portion of the gaseous enriched nitrogen UN₂ is conveyed to the adsorber device 3 and serves as regeneration gas which is conducted through an adsorber during its regeneration phase. Further portions of cold gaseous nitrogen (not shown here) can be used as a product after flowing through the heat exchanger.

The cooled air stream is fed in gaseous or partially liquid form into a region, e.g., central in this case, of the separation column 5 (for example via an expansion valve 4), wherein a feed into other regions, in particular a lower region, of the separation column is also conceivable. A corresponding plant can additionally comprise post-compression of a (partial) air stream and a cooling in a high-pressure heat exchanger. This is also not shown for the sake of clarity. In the case of multiple air fractions, these can be fed (after possible expansion by means of a turbine) at least partially in different regions of the separation column. As already explained, instead of a single separation column 5, as shown in FIG. 1, multiple series-connected separation columns, dual columns and the like can also be used.

The different boiling points of their components are used for breaking down the liquefied air. In the separation column 5, the liquid air trickles downwards over a number of sieve trays, shown highly simplified, in counterflow to the non-liquefied, rising air. In this case, the liquid is collected on the trays and rising steam bubbles flow through. Above all, the higher-boiling oxygen is liquefied from the gas stream, while the lower-boiling nitrogen preferably evaporates from the liquid droplets. Gaseous nitrogen GAN collects for this reason at the cold head of the separation column 5, and liquid oxygen LOX at the warmer bottom.

For further purification of the fractions, the liquid oxygen LOX is evaporated from the bottom of the separation column 5 in an evaporator 6, and the gaseous nitrogen is liquefied in a so-called overhead condenser 7. The evaporated, gaseous oxygen GOX and the liquefied nitrogen LIN are fed back to the separation column 5, where the rectification is repeated until the desired purity is reached.

Correspondingly pure fluids can be removed from the bottom or head of the separation column 5 and stored in liquid tanks 8, 9 for further use.

Furthermore, for example, an oxygen-argon mixture O/Ar can be removed from the separation column 5, from which highly pure argon can be obtained in a separate method in a further column. Separate columns are also required for obtaining the noble gases xenon, krypton, helium and/or neon.

For cooling newly drawn-in air (see above), a portion of the obtained nitrogen GAN is removed and, as explained, returned to the heat exchanger 1, wherein at least a portion can be used after flowing through as regeneration gas.

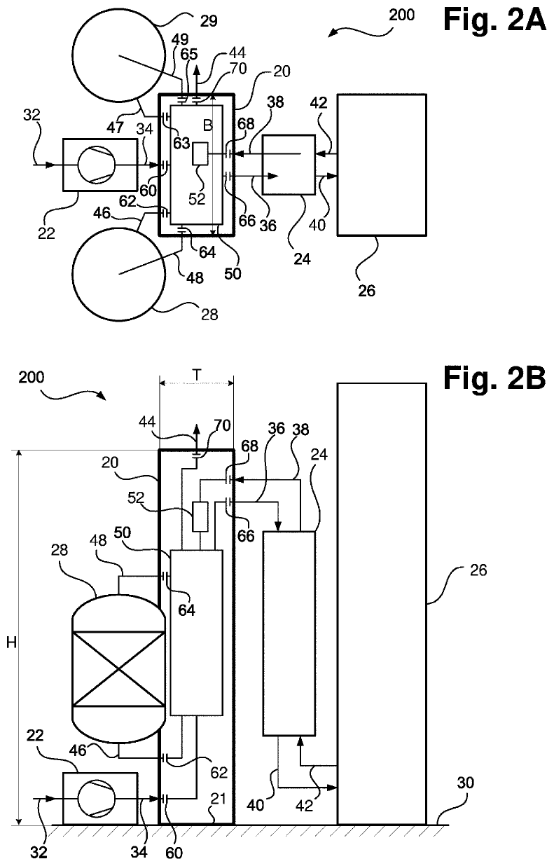

FIGS. 2A and 2B show a plan view (FIG. 2A) and a side view (FIG. 2B) of an air separation plant 200 in which a distributor module 20 according to one embodiment of the invention is arranged.

The shown air separation plant 200 comprises multiple modules, which enables a high degree of prefabrication. In addition to the distributor module 20, a main compressor module 22, a main heat exchanger module 24 and a separating column module 26 are provided. Furthermore, the air separation plant comprises two adsorbers 28, 29. The elements of the air separation plant 200 are arranged on a floor surface 30, for example a concrete slab. Any support frames or stand structures, for example in FIG. 2B for the adsorbers and the main heat exchanger module, are not shown for the sake of clarity, but can of course be provided. Apart from the distributor module 20, instead of the main compressor module, the main heat exchanger module and the separation column module, a non-modular structure consisting of individual elements that are not connected to form a module can also be provided independently of each other, at least in part. Accordingly, instead of the main compressor module, the main heat exchanger module and the separating column module, a main compressor arrangement, a main heat exchanger arrangement and a separating column arrangement, each comprising the same functional elements as the corresponding modules, can be accordingly used independently of one another, wherein the functional elements are merely not connected to form a module. The following statements also apply analogously to corresponding arrangements instead of modules.

A possible support frame on which the components of the distributor module are mounted or fastened is not shown in the figure.

Air 32 from the surroundings or atmosphere is sucked in through the main compressor module 22 and compressed (e.g., to a pressure in the range of 4-30 bar). In addition to the symbolically represented main compressor, the main compressor module 22 generally comprises a filter with which the air drawn in is filtered before compression, and a cooling device with which the compressed air is cooled again (e.g., to about 20° C., not shown). For this purpose, the cooling device can use water, wherein the cooling takes place by means of contact cooling and/or evaporative cooling. One or more main compressor modules or main compressor arrangements can be provided. The air is generally cooled after the last compressor stage before entry into the distributor module, for example in an aftercooler, with a refrigeration system or a direct contact cooler.

The compressed air is guided via a fluid line, referred to as a compressor line 34, to the distributor module 20, through which the air is guided into a fluid line, referred to as the first adsorber line 46, 47, to an adsorber which is in the adsorption phase. After flowing through the adsorber, the purified air is returned via another fluid line, referred to as the second adsorber line 48, 49, to the distributor module 20, and is conducted therefrom into a fluid line, referred to as a first heat exchanger line 36 which is connected to the main heat exchanger module 24. In principle, multiple first heat exchanger lines and corresponding connections can also be provided here in the distributor module if the air is already divided into multiple fractions in the distributor module.

The main heat exchanger module 24 comprises a main heat exchanger, for example arranged in a cold box, in which the compressed, purified air is cooled in counterflow with one or more cold fluid flows coming from the separating column module 26. Possible cold fluid flows are gaseous nitrogen (e.g., UN₂ and/or GAN) and gaseous oxygen (GOX). One of these cold fluid flows, preferably gaseous enriched nitrogen UN₂, is fed as regeneration gas through a fluid line, referred to as the second heat exchanger line 38, from the main heat exchanger module 24 to the distributor module 20.

Although not shown in detail, multiple fluid lines from the main heat exchanger module to the distributor module are generally provided for this (i.e., for the different cold fluid flows), for example the second heat exchanger line 38 for gaseous enriched nitrogen UN₂ and a further fluid line (not shown) for gaseous pure nitrogen GAN. In addition to the second heat exchanger connection 68 (see below), further connections can then be in the distributor module which enable a fluidic connection to these fluid lines coming from the main heat exchanger module. Fluid lines connected to these connections can be provided in the distributor module, which enable the different fluid flows which come from the main heat exchanger module to be passed on. In particular, fluid lines and devices (valves, connections) connected to the connections can be provided which enable a discharge (e.g., as product flows) of one or more of the fluid flows, for example, it can be provided that gaseous pure nitrogen GAN is discharged as a product.

The compressed, purified, cooled air is conducted from the main heat exchanger module 24 through at least one fluid line 40 to the separating column module 26 in which the air separation, i.e., the separation of the air into its constituents, takes place (as already described in connection with FIG. 1). For this purpose, the separation column module 26 comprises one or more separating columns which are arranged, for example, in a cold box. If multiple air fractions are cooled through the main heat exchanger module, multiple fluid lines can be accordingly provided here between the main heat exchanger module and the separating column module.

From the separating column module 26, the one or more cold fluid flows are guided through at least one fluid line 42 to the main heat exchanger module 24. Any fluid lines and/or containers which are provided for liquid and/or gaseous products (i.e., separated components of the air) are not shown in FIGS. 2A, 2B.

The regeneration gas supplied from the main heat exchanger module 24 via the fluid line (second heat exchanger line) 38 is fed from the distributor module into a fluid line (second adsorber line) to an adsorber which is in the regeneration phase. The regeneration gas returned via a further fluid line (first fluid line) from the adsorber to the distributor module 20 is released to the surroundings as a residual gas via a residual gas outlet 44.

The distributor module 20 has a floor side 21 on which it can be arranged upright on the floor surface 30. A vertical dimension or height h of the distributor module, i.e., a dimension of the distributor module 20 perpendicular to the floor side 21, is greater than a transverse dimension of the distributor module, i.e., a dimension of the distributor module 20 parallel to the floor side 21. A maximum dimension parallel to the floor side can be used as a transverse dimension, for example. Likewise, an average dimension parallel to the floor side can be used as a transverse dimension. The root of the surface area of the floor side could also be used as a transverse dimension. In the case of a substantially cuboid distributor module (as shown), i.e., the floor side forms a rectangle with a depth T and a width B, the larger of width B and depth T or an average of width B and depth T could be used as the transverse dimension, for example.

The height H of the distributor module is preferably at least 1.5 times, more preferably at least 2 times, even more preferably at least 3 times, the transverse dimension of the distributor module. The advantages of a distributor module characterized in this way are, on the one hand, that the elements of the distributor module can be arranged vertically therein, so that the space required when the distributor module is positioned upright on the floor side is small compared to a horizontal arrangement, and thus a total area of the air separation plant can be kept relatively small. On the other hand, a horizontal transport of the distributor module over roads from a production plant to the air separation plant, more precisely its construction site, is possible. Furthermore, lines and connections for connecting the heat exchanger module and the vertical distributor module are substantially shorter and integrated in the distributor module and do not have to be installed on the construction site.

For example, the transverse dimension can be in the range from 3 m to 7 m, preferably in the range from 3.5 m to 6 m, and the height H can be greater than 10 m, preferably in the range from 10 m to 30 m, more preferably in the range from 15 m to 25 m, even more preferably in the range from 15 m to 20 m. In the case of a cuboid distributor module, the depth T and the width B can in this case each lie independently of one another within the mentioned ranges for the transverse dimension (i.e., in the range from 3 m to 7 m, preferably in the range from 3.5 m to 6 m). For example, a distributor module could have a height H (corresponding to a transport length in horizontal transport) of about 23 m, a depth T (corresponding to a transport width) of about 5.2 m, and a width B (corresponding to a transport height) of about 4.8 m.

Fluid connections for connection to the fluid lines already mentioned above are provided in the distributor module 20. In particular, the following fluid connections are provided: a compressor connection 60 for connection to the compressor line 34, for each adsorber a first adsorber connection 62, 63 for connection to the first adsorber line 46, 47, for each adsorber a second adsorber connection 64, 65 for connection to the second adsorber line 48, 49, a first heat exchanger connection 66 for connection to the first heat exchanger line 36, a second heat exchanger connection 68 for connection to the second heat exchanger line 38, and a residual gas connection 70 for connection to the residual gas outlet 44; and possibly others for connecting an evaporative cooler and/or for connecting or discharging products such as GAN, PGAN, GAN IC, GOXIC, GOX. The first adsorber connection and the second adsorber connection, which are associated with the same adsorber, each form a connection pair (46, 48, and 47, 49). If, as preferred, the residual gas outlet is integrated in the distributor module, a residual gas connection can be dispensed with. If two or more (main) heat exchangers are comprised in the main heat exchanger module (cold box), the process lines can be routed separately to the distributor module and combined or led together there, or can already be combined in a separate module which is arranged at the main heat exchanger module or is integrated therein.

A valve and flap assembly 50 is enclosed in the distributor module 20, wherein the aforementioned connections are each comprised independently of one another in the valve and flap assembly 50 or are connected thereto by means of fluid lines. The valve and flap assembly 50 comprises valves and/or flaps which can be controlled in such a way that each connected adsorber or the connection pair connected thereto (connection pair associated therewith) can optionally be operated in a first and a second state. In the first state, the compressor connection is fluidically connected to the first adsorber connection, and the second adsorber connection is fluidically connected to the first heat exchanger connection, the air flow coming from the main compressor module is thus first guided into the adsorber (which is in the adsorption phase) and then conducted to the main heat exchanger module. In the second state, the second heat exchanger connection is fluidically connected to the second adsorber connection, and the first adsorber connection is connected to the residual gas connection or residual gas outlet, and the regeneration gas flow coming from the main heat exchanger module is thus first conducted into the adsorber (which is in the regeneration phase) and is then discharged to the surroundings. The adsorbers can thus be operated alternately in the adsorption phase and the regeneration phase without interrupting the operation of the air separation plant.

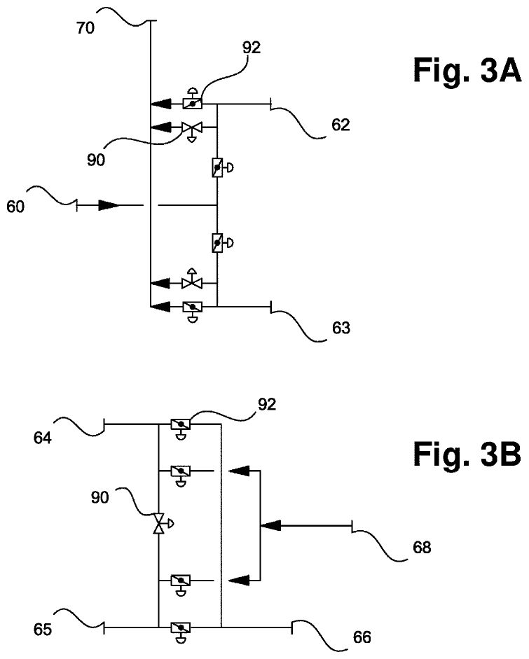

Such arrangements of valves or flaps are known per se to a person skilled in the art (such as H.-W. Häring (pub.), Industrial Gases Processing, Wiley-VCH, 2006, in particular FIG. 2.3A therein). According to the present invention, these are, however, arranged in the distributor module. For the sake of completeness, a corresponding valve and flap assembly is shown in FIGS. 3A and 3B, wherein the connections are each provided with reference signs. In this regard, FIG. 3A shows the arrangement of valves 90 and flaps 92 (which can be referred to as first valves and/or flaps) (only some of which are shown representatively with reference signs) that connect the first adsorber connections 62, 63 to the compressor connection 60 and the residual gas connection 70, and FIG. 3B shows the arrangement of valves/flaps (which can be referred to as second valves and/or flaps) that connect the second adsorber connections 64, 65 to the first heat exchanger connection 66 and the second heat exchanger connection 68. It should be noted here that the positioning of the connections in the figures is merely schematic and does not necessarily correspond to an actual position, and therefore the different positioning in FIGS. 3A, 3B, compared to FIGS. 2A, 2B, is only due to the simplicity of the illustration. The valves/flaps of FIG. 3A are preferably arranged in a horizontal plane; the valves/flaps of FIG. 3B are preferably arranged in a vertical plane. The valves/flaps of FIG. 3B are preferably arranged above the valves/flaps of FIG. 3B.

A regeneration gas heater 52 is preferably installed in the distributor module 20 in order to heat the regeneration gas during the warm-up phase of the regeneration phase of an adsorber. The regeneration gas heater is connected to the second heat exchanger connection 68 and is arranged between it and the valve and flap assembly 50 to which it is connected by means of a fluid line. Alternatively, a regeneration gas heater could also be erected next to the distributor module. However, integration into the distributor module 20 is advantageous since the degree of prefabrication can thus be further increased.

The residual gas outlet 44 preferably also integrated into the distributor module. In particular, a blowdown silencer (not shown) can be installed on the residual gas outlet and on the distributor module.

If a division into multiple air fractions of the compressed, purified air stream coming from one of the adsorbers and/or a post-compression of the air flow or an air fraction is provided, corresponding fluid lines and valves and/or possibly provided compressors can likewise be installed in the distributor module. The same applies to all fluid lines of the products (N2, Argon, O2) which are conducted from the heat exchanger via fluid lines and devices (valves, connections) which are integrated in the distributor module. Preferably, shut-off flaps, quantity and temperature measuring devices, and the connections for further connection to the end user (via a subsequent pipe bridge, etc.) are preferably also arranged on the distributor module.

1. A distributor module for a process engineering system, which is connected to a main air compressor arrangement, at least two adsorbers, each of which can be operated in an adsorption phase and a regeneration phase, and a main heat exchanger arrangement can be connected by means of fluid lines, comprising:
a compressor connection, for each adsorber to be connected, a connection pair with a first adsorber connection and a second adsorber connection, a first heat exchanger connection and a second heat exchanger connection, and a residual gas connection or a residual gas outlet; and
a valve and flap assembly that is optionally configured for each connection pair:
in a first state of the connection pair, to fluidically connect the compressor connection to the first adsorber connection of the connection pair and fluidically connect the second adsorber connection of the connection pair to the first heat exchanger connection; and,
in a second state of the connection pair, to fluidically connect the second heat exchanger connection to the second adsorber connection of the connection pair, and to fluidically connect the first adsorber connection of the connection pair to the residual gas connection or a residual gas outlet,
wherein the distributor module has a floor side, and a height of the distributor module measured perpendicular to the floor side is greater than both transverse dimensions of the distributor module measured parallel to the floor side.

2. The distributor module according to claim 1, wherein the height is at least 1.5 times, preferably at least 2 times, greater than the transverse dimensions.

3. The distributor module according to claim 1, wherein the transverse dimensions are each one of the following dimensions:
a maximum dimension of the distributor module parallel to the floor side;
an average dimension of the distributor module parallel to the floor side; and,
the root of an area of the floor side.

4. The distributor module according to claim 1, having connections which can be connected to the warm end of the main heat exchanger arrangement by means of fluid lines, wherein these connections are arranged in the upper third of the height of the distributor module.

5. The distributor module according to claim 1, having a connection which can be connected to the main air compressor arrangement via a fluid line, wherein this connection is arranged in the upper third of the height of the distributor module.

6. The distributor module according to claim 1,
wherein first valves and/or flaps which shut off/release the fluid flows to the adsorbers or to the connection pairs are arranged horizontally or almost horizontally in the distributor module or in the valve and flap assembly, i.e., the connection lines to which the corresponding valve is connected are arranged horizontally or almost horizontally; and/or,
wherein second valves and/or flaps, which shut off/release the fluid flows between connection pairs and the heat exchanger connections, are arranged in a vertical or almost vertical plane in the distributor module or in the valve and flap assembly, that is, the connection lines to which the corresponding valve is connected are arranged in a vertical or almost vertical plane;
wherein the second valves and/or flaps are preferably arranged spatially above the first valves and/or flaps; and,
wherein preferably the first and/or second flaps, in particular if these are designed as three-lever flaps, are arranged horizontally or almost horizontally, i.e., the connecting lines to which the corresponding flap is connected are arranged horizontally or almost horizontally.

7. The distributor module according to claim 1, comprising a regeneration gas heater that is fluidly connected to the second heat exchanger connection.

8. The distributor module according to claim 1, comprising a blowdown silencer arranged on the residual gas connection or residual gas outlet.

9. The distributor module according to claim 1, comprising a support frame, in particular a steel support frame, on which are mounted the valve and flap assembly, and/or the regeneration gas heater and/or optionally a control unit, and/or; the blowdown silencer, wherein fluid lines for connecting these elements, and for connecting to the compressor connection, the first and the second heat exchanger connection, and the first and the second adsorber connection, are also mounted on the support frame.

10. The distributor module according to claim 9, wherein the support frame is substantially cuboid and has a length, a width and a depth; wherein the height equal to the length and the transverse dimension is equal to the width, the depth, or an average thereof; wherein preferably the width and the depth are independently of one another in the range of 3.5 m to 7 m, and preferably the length is in the range of 10 m to 30 m.

11. The distributor module according to claim 1, configured, when the distributor module is connected to the main air compressor arrangement, the at least two adsorbers and the main heat exchanger arrangement, for each of the adsorbers, independently of each other,
to direct an air flow to the adsorber during the adsorption phase of the respective adsorber, and to direct it from the adsorber to the main heat exchanger arrangement after flowing through the adsorber; and,
during the regeneration phase of the respective adsorber, to direct a regeneration gas flow from the main heat exchanger arrangement to the adsorber and, after flowing through the adsorber, to direct it to a residual gas outlet.

12. The distributor module according to claim 1, comprising a control unit which is configured to control the valve and flap assembly, wherein a connection pair is operated according to the first state in order to operate the adsorber connected thereto in the adsorption phase, and is operated according to the second state in order to operate the adsorber connected thereto in the regeneration phase, wherein preferably, the control unit is configured to control the valve and flap assembly so that at least one pair of connections is operated alternately according to the first state.

13. An air separation plant comprising a distributor module according to claim 1 and further comprising a main air compressor arrangement, at least two adsorbers, each of which can be operated in an adsorption phase and a regeneration phase, and a main heat exchanger arrangement which are connected to the distributor module by means of fluid lines.

14. The air separation plant according to claim 13, comprising a separation column arrangement, wherein the main heat exchanger arrangement is arranged between the distributor module and the separation column arrangement, and wherein the main heat exchanger arrangement is preferably mounted in a main heat exchanger module, and/or the separation column arrangement is mounted in a separation column module.

15. The air separation plant according to claim 13, wherein the height of the distributor module in relation to a heat exchanger height of the main heat exchanger arrangement or the main heat exchanger module is between the heat exchanger height minus 5 m and heat exchanger height plus 5 m, wherein the height of the distributor module is preferably greater than the heat exchanger height.
